(19) United States
(12) Patent Application Publication
(10) Pub. No.: US 2015/0376030 A1
(43) Pub. Date: Dec. 31, 2015

(54) DESALINATION SYSTEM AND PROCESS USING ATMOSPHERIC PRESSURE AS RENEWABLE ENERGY

(71) Applicant: Marvin W. Pierre, Virginia Beach, VA (US)

(72) Inventor: Marvin W. Pierre, Virginia Beach, VA (US)

(21) Appl. No.: 14/848,577

(22) Filed: Sep. 9, 2015

Related U.S. Application Data
(63) Continuation of application No. PCT/US2014/047943, filed on Jul. 24, 2014.
Application No. PCT/US2014/047943 is a continuation-in-part of application No. 13/434,516, filed on Mar. 29, 2012, now Pat. No. 9,162,889.
(60) Provisional application No. 61/858,432, filed on Jul. 25, 2013.
(60) Provisional application No. 61/486,596, filed on May 16, 2011.
(60) Provisional application No. 61/608,428, filed on Mar. 8, 2012.
(60) Provisional application No. 61/613,728, filed on Mar. 21, 2012.

(51) Int. Cl. C02F 1/06; B01D 3/00; F04B 9/06; B01D 5/00; C01B 5/00; B01D 1/14; B01D 3/34

(52) U.S. Cl. CPC C02F 1/06; B01D 1/14; B01D 3/007; B01D 3/346; B01D 5/006; C01B 5/00; F04B 9/06; C02F 2103/08

(57) ABSTRACT

A system configured according to principles of the disclosure and process performed according to principles of the disclosure exploit a phase change cycle associated with cavitation on the suction side of (or inside) a pump to separate salt and/or impurities from water with exceptional efficiency. The exploitation involves enhancing the well-known process of cavitation by providing a large container in which the phase changes can occur safely, creating initial vapor inside the large container to start and perpetuate the process, using atmospheric pressure to drive water or recycled water into (or downstream of) the large container to force vapor compression and condensation inside the large container, and then providing a heat exchanger inside the large container to transfer heat released by condensation and vapor compression from its freshwater side to its vaporization side. A specialized pump configured to handle very low pressure conditions on its suction side more effectively and efficiently than other pumps may be used. The system and process may produce freshwater at about 0.01 gpm to about 1,080 gpm, or more.

### CROSS REFERENCE TO RELATED APPLICATIONS

This application claims benefit and priority from International Application No. PCT/US2014/047943, filed Jul. 24, 2014, which is based on and claims priority to U.S. Provisional Patent Application No. 61/858,432, filed Jul. 25, 2013, the disclosures of which would be incorporated therein by reference in their entireties. This application also claims the benefit as a continuation-in-part of U.S. patent application Ser. No. 13/434,516, filed Mar. 29, 2012, which is based on and claims priority to U.S. Provisional Patent Applications, Nos. 61/486,596, 61/608,428, and 61/613,728, filed May 16, 2011, Mar. 8, 2012, and Mar. 21, 2012, respectively, the disclosures of which are also incorporated herein by reference in their entireties.

### BACKGROUND

1. Field of the Disclosure

This present disclosure relates to a system and method for water purification and, more particularly, to a system and method for desalinating salt water and may include exploiting the phase change cycle associated with cavitation on the suction side or inside of a pump to desalinate source seawater with exceptional efficiency, among other features.

2. Related Art

Demand for freshwater is becoming more acute world-wide. Most of the world's total water is seawater, with a smaller amount being freshwater. Processes in place for converting seawater to freshwater are still economically unattractive for wide spread use. Two basic technologies exist to desalinate seawater. The first is thermal desalination, the second is membrane desalination. Nearly all current processes can be categorized as either thermal or membrane desalination. Both of these techniques require substantial amounts of energy to accomplish the desalination process, which is a significant economical barrier for common use. For membrane techniques, large pressures and energy have to be employed. For thermal techniques, large amounts of heat must be utilized to cause evaporation.

A new technique that does not require the introduction of large amounts of energy into the desalination process supported by ambient temperatures and pressures would promote greater production of freshwater from seawater.

### SUMMARY OF THE INVENTION

In one aspect, the system and process of the present disclosure exploits the phase change cycle associated with cavitation on the suction side of (or inside) a pump to desalinate source seawater with exceptional efficiency. The pump is specialized to handle the very low pressure conditions on its suction side much more effectively and efficiently. The exploitation involves enhancing the well-known process of cavitation by providing a large container in which the phase changes can occur safely, creating initial vapor inside the large container to start and perpetuate the process, using atmospheric pressure to drive recycled water into (or downstream of) the large container to force vapor compression and condensation inside the large container, and then providing a heat exchanger inside the large container to transfer heat released by condensation and vapor compression from its freshwater side to its vaporization side.

Once initial vapor creation is completed, the system and/or process may begin a continuous production flow. The total energy input required to maintain continuous flows is satisfied by two distinct sources. Renewable energy in the form of atmospheric pressure acts as one source, and electrical energy (which may be derived from fossil fuels) acts as the other source. However, the renewable energy input provides at least 99.0% of the total energy required. Computer model runs and laboratory experiments indicate that for every cubic meter of freshwater produced, the system and/or process can operate using 50 to 55 kWh of work energy inputted from atmospheric pressure, and only 0.12 to 0.24 kWh of work energy inputted from electrical or fossil fuel sources. Also, approximately 650 kWh of heat energy is released during condensation and vapor compression, transferred within the system's vaporization chamber, and absorbed for vaporization for every cubic meter of freshwater produced.

In one aspect, a system for desalination of saltwater is provided comprising a containment vessel configured to substantially enclose an upstream containment section and a downstream containment section, the upstream containment section configured to contain saltwater, the downstream section configured to contain freshwater, wherein the containment vessel is configured to permit a phase change to occur above both the upstream containment section and the downstream containment section via a gas canopy comprising a mixture of water vapor and air, a heat exchanger that separates the upstream containment section from the downstream containment section and configured to pass heat from the downstream side to the upstream side to promote continual vaporization of the saltwater and a pump system to pump both saltwater from a saltwater source into the upstream containment section and to pump condensed freshwater from the downstream containment section, wherein friction in piping and fittings on a suction side of the pump system assists in lowering pressure in the containment vessel, wherein water is introducible into the downstream containment section or into a suction line connected to the downstream containment section by using atmospheric pressure to assist in forcing vapor compression and condensation within the containment vessel to produce freshwater in the downstream containment section. In one aspect, the containment vessel may be configured with a vent configured to vent air into the pump system to release pressure that has been created by air coming out of solution in the containment vessel due to an increase in vacuum within the containment vessel and wherein the pump system is configured to receive the vented air. The atmospheric pressure acts as renewable energy for forcing compression and condensation of the vapor, and to reduce energy consumption for the desalination. The pump system may comprise a plurality of spring-loaded pumps configured to pump the saltwater/brine and the freshwater simultaneously therewithin. The pump system may comprise at least one spring loaded pump configured with an expansion cavity that expands primarily by spring-loaded force and the at least one spring loaded pump is configured to operate at low pressure conditions on its suction side of less than ambient atmospheric pressure. Each of the plurality of spring-loaded pumps may be configured with an expansion cavity that is configured to be compressed by a pump press device.

The system may further comprise at least one valve that controls friction imparted to a flow of saltwater on the suction side of the pump system comprising at least one spring-loaded pump to lower pressure of the saltwater towards the vaporization point causing vaporization of the saltwater within the containment vessel to produce water vapor and a source configured to inject water, air, or both into the containment vessel to force condensation of the water vapor into the downstream containment section thereby assisting desalinating the saltwater to produce freshwater. The injected water and/or air may be injected with a higher pressure and a higher temperature than the produced water vapor. The injected water and/or air may be injected with a higher pressure and a temperature that is about equal to or lower than the produced water vapor.

The system may consume about 0.12 to about 0.24 kWh of electrical energy or fossil fuel per cubic meter of freshwater produced. Moreover, freshwater production rate of about 1,080 gpm or greater is achievable.

In one aspect, the system may consume from about 50 to about 300 kWh of renewable energy per cubic meter of freshwater produced, the renewable energy being in the form of atmospheric pressure. The heat exchanger may recycle about 650 kWh of heat energy per cubic meter of freshwater produced.

The system may further comprise a brine modulating valve located between the upstream containment section of the vaporization chamber and the pump system to assist in maintaining desired water level in the upstream containment section, and assist in balancing pressure exerted on the pump system. The system may further comprise a freshwater modulating valve positioned on a freshwater suction line between the downstream containment section and the pump system to ensure that condensation occurs in the containment vessel, and assist in maintaining desired water level in same downstream containment section.

### BRIEF DESCRIPTION OF THE DRAWINGS

The accompanying drawings, which are included to provide a further understanding of the invention, are incorporated in and constitute a part of this specification, illustrate examples of the invention and together with the detailed description serve to explain the various principles of the present disclosure. No attempt is made to show structural details of the invention in more detail than may be necessary for a fundamental understanding of the invention and the various ways in which it may be practiced.

FIG. 1A shows a plan view of a system, configured according to principles of the disclosure, with arrows showing the flow direction of respective streams;

FIG. 1B shows a section view of the system of FIG. 1A;

FIG. 1C shows an enlarged section view of the vaporization chamber, including pertinent components and arrows showing the flow direction of respective streams;

FIG. 2A shows section views of the pump spring in an uncompressed state, configured according to principles of the disclosure;

FIG. 2B shows section views of the pump spring in a compressed state, configured according to principles of the disclosure;

FIG. 2C shows a section view of the complete pump, with the pump press in an extended state, configured according to principles of the disclosure;

FIG. 2D shows a section view of the pump of FIG. 2C, with the pump press in a recessed state, configured according to principles of the disclosure;

FIG. 3 shows a total energy equation describing aspects of a desalination system, according to principles of the disclosure;

FIG. 4 is an example flow diagram of a process, the steps of the process performed according to principles of the disclosure; and

FIG. 5 is an example flow diagram of a process, the steps of the process performed according to principles of the disclosure.

### DETAILED DESCRIPTION OF THE INVENTION

The disclosure and the various features and advantageous details thereof are explained more fully with reference to the non-limiting examples that are described and/or illustrated in the accompanying drawings and detailed in the following description. It should be noted that the features illustrated in the drawings are not necessarily drawn to scale, and features of one example may be employed with other examples as the skilled artisan would recognize, even if not explicitly stated herein. Descriptions of well-known components and processing techniques may be omitted so as to not unnecessarily obscure the principles of the disclosure. The examples used herein are intended merely to facilitate an understanding of ways in which the disclosure may be practiced and to further enable those of skill in the art to practice the examples of the disclosure. Accordingly, the examples herein should not be construed as limiting the scope of the disclosure. Moreover, it is noted that like reference numerals represent similar parts throughout the several views of the drawings.

The terms “including”, “comprising” and variations thereof, as used in this disclosure, mean “including, but not limited to”, unless expressly specified otherwise. The term “about” herein means within 10% of the specified amount or number, unless context states otherwise.

The term “about” and “approximately” used herein means within +/−10%, unless context states otherwise. The terms “a”, “an”, and “the”, as used in this disclosure, means “one or more”, unless expressly specified otherwise.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like. Further, the computer may include an electronic device configured to communicate over a communication link. The electronic device may include a computing device, for example, but is not limited to, a mobile telephone, a personal data assistant (PDA), a mobile computer, a stationary computer, a smart phone, mobile station, user equipment, or the like.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features. The system and process described herein is applicable for processing water including seawater and/or saltwater. The system and process described herein is also applicable for processing water that is not considered saltwater, such as, e.g., from lakes and/or streams, for removing impurities. If the system and process described herein is being used to purify non-saltwater, such as from lakes or streams, then the references herein to “brine” should be considered instead as “waste water.”

An interesting phenomenon can occur on the suction side of a pump for pumping water. If conditions are right, vapor bubbles can form and subsequently collapse within the suction lines of the pump. At times, vapor bubble formation and collapse can occur within the pump itself. What is interesting about this phenomenon, called cavitation, is the fact that phase changes are occurring without the input of tremendous amounts of energy from electrical, fossil fuel, or otherwise man-made sources.

Generally, a medium such as water requires a relatively large input of heat energy (approximately 650 kWh) to transform a cubic meter of liquid into vapor. Then, to change the vapor back to liquid form, work energy needs to be added to compress the vapor to the point at which it condenses into a cubic meter of liquid again. However, cavitation may occur without intentionally adding this heat and work. The energy required to complete the phase changes associated with cavitation may be provided by the environment and the dynamic forces of the flowing medium.

With the realization that phase changes can sometimes occur with less electrical or fossil fuel energy than usual, the potential to greatly improve the energy efficiency of processes dependent upon vaporization and condensation becomes evident. The process of the present disclosure may separate salt from water in typical seawater (approximately 3.5% salinity per unit of pure water) with minimum electrical energy input, and instead energy from the environment can be used to satisfy the heat and work requirements needed to complete the phase transformation cycle.

Cavitation is an existing process that occurs on the suction side of, or within, a pump. Cavitation begins when the pressure surrounding the flowing liquid is reduced to the liquid's own vapor pressure, thereby allowing vaporization to take place. The more heat that is available from the environment, the more vapor that will be created at the vaporization point. Following vaporization, cavitation then involves the collapse or implosion of the formed vapor bubbles back into liquid form. This implosion is made possible by the flow velocity and liquid viscosity forces acting upon the vapor, causing compression and ultimately condensation. For cavitation occurring inside the pump, atmospheric pressure from the discharge side also contributes greatly in vapor compression and condensation. When the vapor bubbles condense into liquid, tremendous amounts of energy in the form of heat may be released. This released heat energy often is so powerful that it can damage the inner walls of suction lines and the internal components to pumps and fittings.

To exploit cavitation for desalination purposes, the process of the disclosure includes creating more ideal conditions where large scale production of freshwater from seawater can thrive. The more ideal conditions for the phase change cycle associated with cavitation may be achieved by providing at least the following idealized conditions:
Provide a large container (or containment vessel) on the suction side of the pump at which the phase change cycle can occur consistently, rapidly, and safely (without causing damage to pipe and pump infrastructure).
Initially provide adequate vapor inside the large container to start cavitation's phase change cycle and allow the process to continue at meaningful production rates.
Use atmospheric pressure to introduce a smaller volume of water at the downstream end of the large container, or in the suction line infrastructure after the downstream end of said container, to force vapor compression and condensation within the large container.
Provide a heat exchanger within the large container to allow the heat released from compression and condensation to flow where needed for vaporization, thereby allowing the phase change cycle to repeat.

The system and process of the present disclosure utilizing these idealized conditions enhance the phase change cycle involved with cavitation to produce freshwater from saltwater with significant productivity and exceptional energy efficiency.

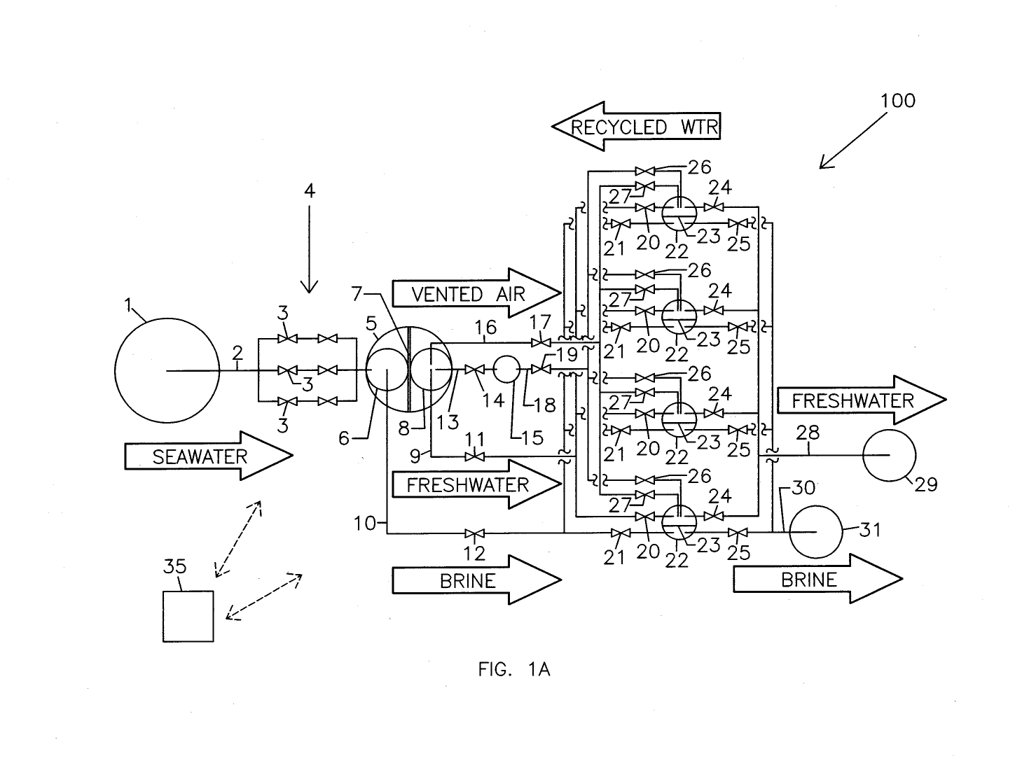

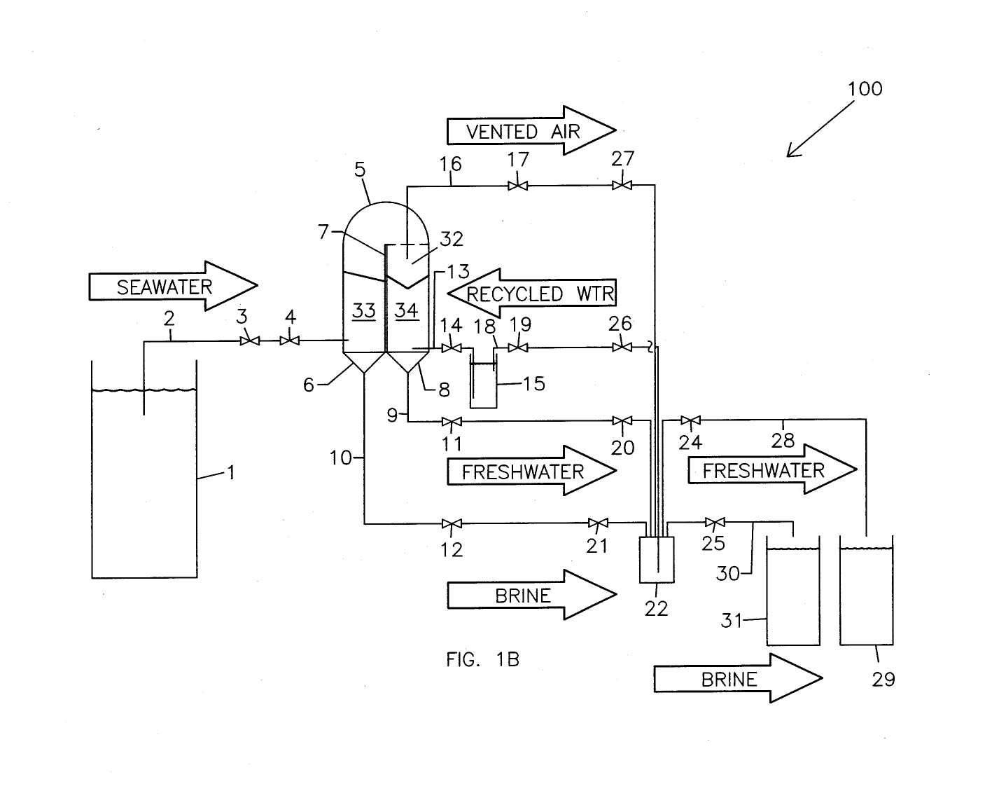

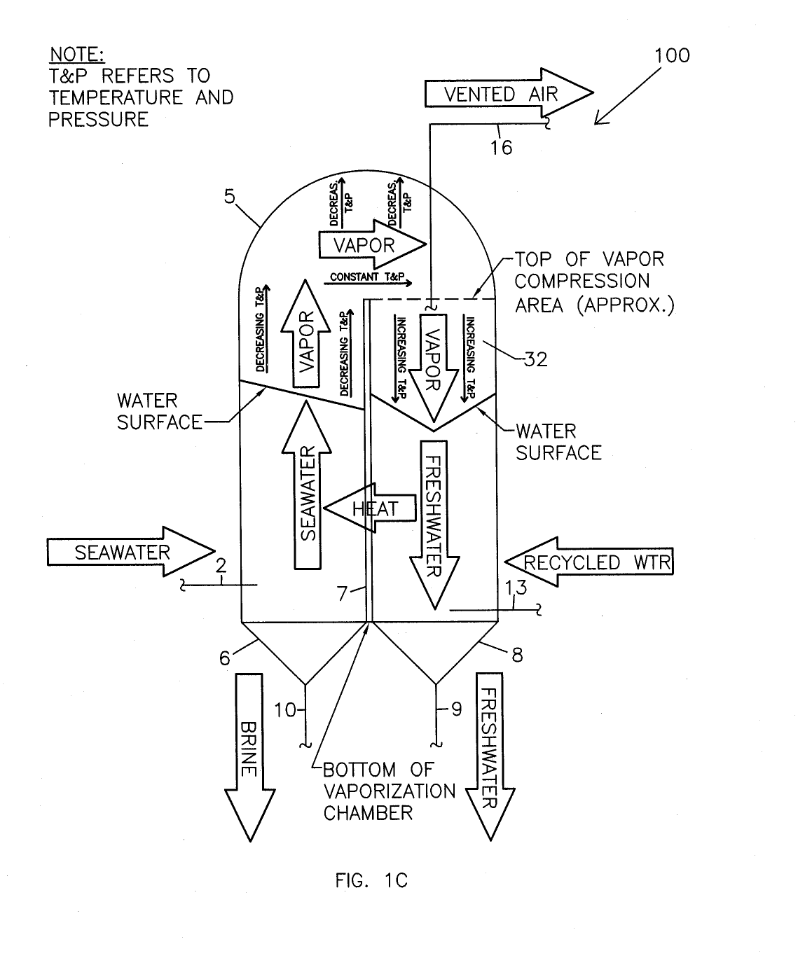

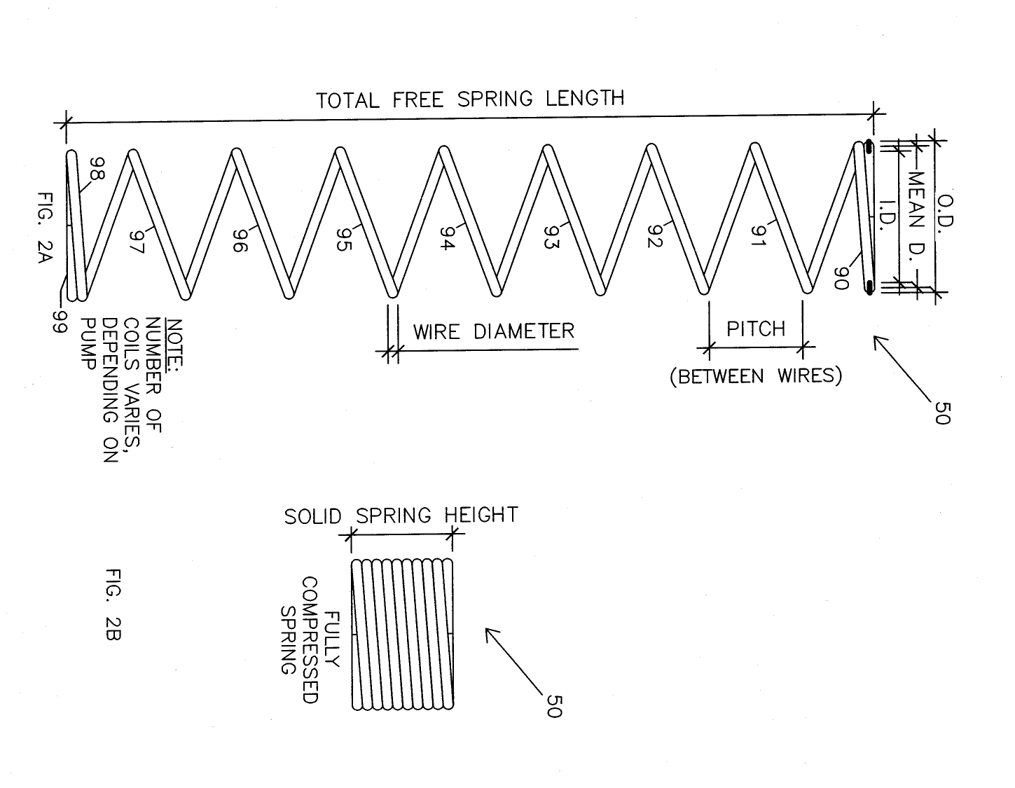

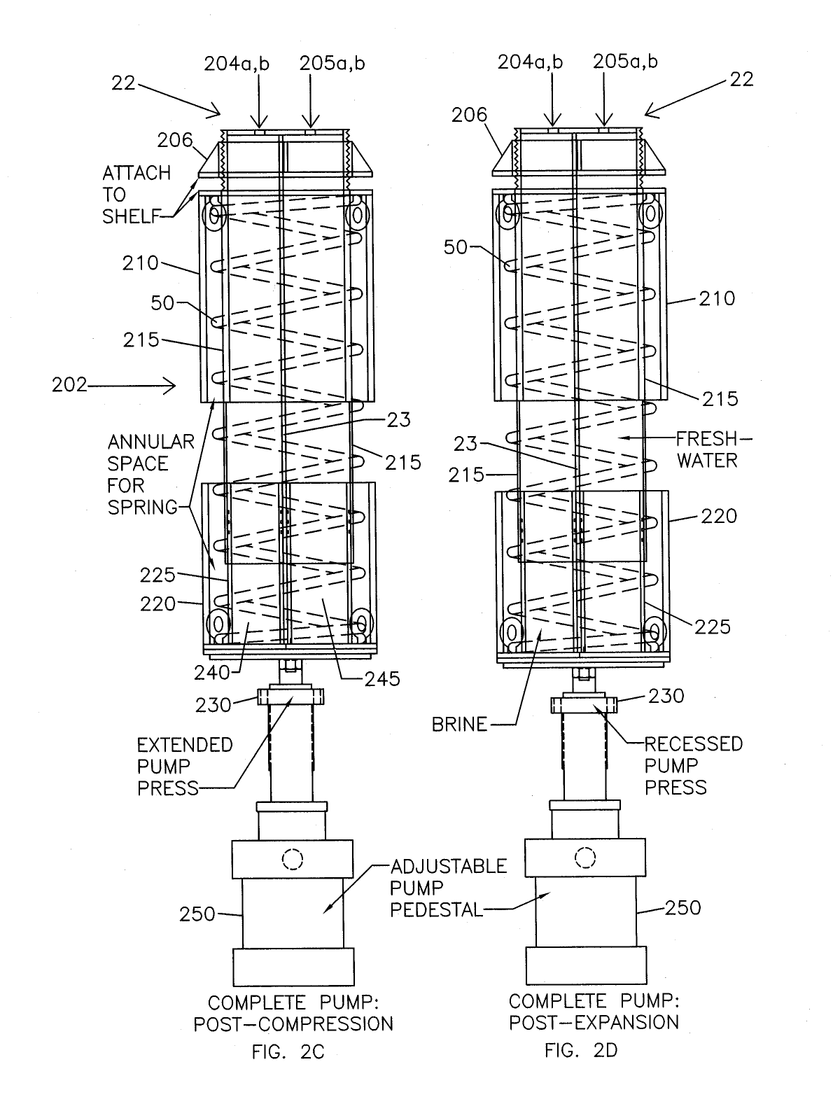

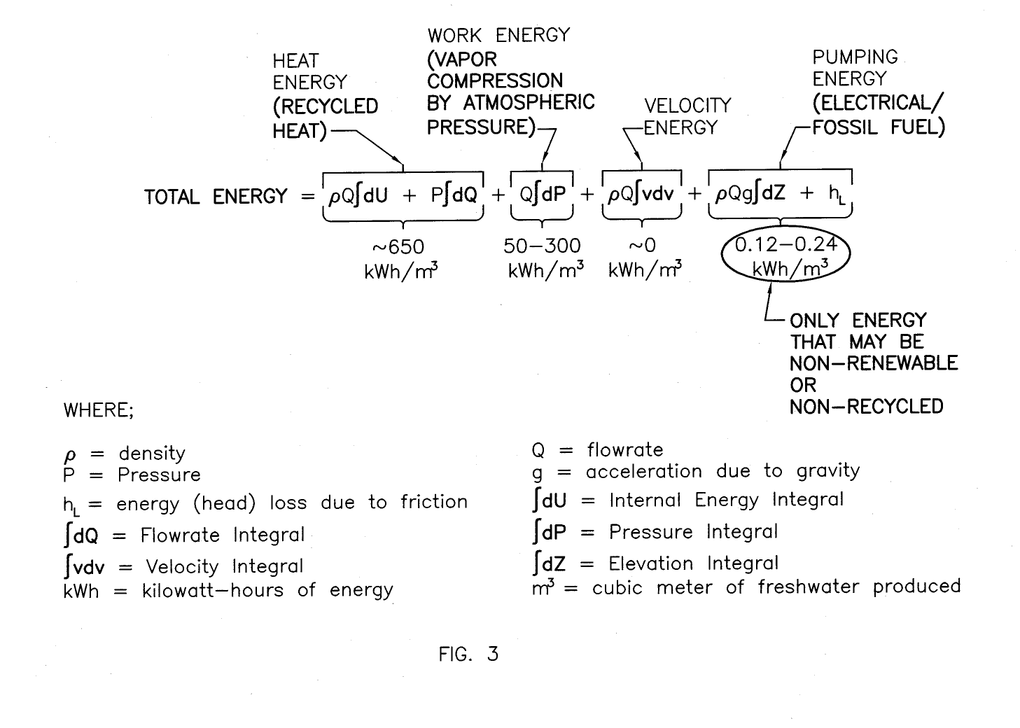

FIG. 1A is a plan view of a system 100, configured according to principles of the disclosure, with arrows showing the flow direction of respective streams. FIG. 1B is a section view of the system of FIG. 1A. FIG. 1C shows an enlarged section view of the vaporization chamber 5, of FIGS. 1A and 1B. The system 100 may be configured with a seawater source 1 and may be configured with one or more of each of the following:
Seawater suction line 2 comprising piping that transports seawater from the source to the vaporization chamber.
Seawater valves comprising a collection of valves 4 designed to impart friction and lower the pressure exerted upon the flowing seawater. In addition to lowering pressure, the collection of valves 4 is intended to ensure that vaporization takes place within the vaporization chamber 5. In this version of the system 100, the collection of valves 4 includes six ball or elliptical valves 4, with three also being modulating valves 3. All six valves 4 may be electrically actuated through a control panel 35.
Vaporization chamber 5 (or containment vessel) comprising a container in which vaporization, vapor compression, condensation, and heat transfer may occur. The vaporization chamber is configured to contain seawater in a first section 33 and configured to contain freshwater in a second section 34.
Heat exchanger 7 comprising a wall inside the vaporization chamber 5 that separates the upstream seawater and brine from the downstream freshwater. In addition, the heat exchanger 7 may be configured to provide a path for heat to flow from the freshwater side, in the second section 34 (where condensation takes place) to the seawater/brine side, in the first section 33 (where vaporization takes place). In some applications, the heat exchanger 7 may also be capable of providing heat for the initial vaporization of the chamber 5.
Water injection line 13 which may comprise a line that injects water, or recycled water, at atmospheric pressure into, or immediately downstream of, the vaporization chamber 5. The purpose of this line 13 is to utilize atmospheric pressure to force vapor compression and condensation in the vaporization chamber 5. The water injection line 13 may be positioned near the bottom of the vaporization chamber 5 (on the freshwater side, as shown in FIG. 1B).
Water injection valve 14 which may comprise a modulating valve that controls the flow of water entering the system at, or near, the vaporization chamber 5. The water injection valve 14 may be a manually actuated needle valve.
Air vent 16 comprising tubing that allows non-condensable gases to escape from the vapor compression zone to one or more spring-loaded pumps 22. A check valve 27 may be installed on the air vent tubing to prevent the backflow of water from inside the pump 22.
Air vent valve 17 configured to control the amount of air leaving the vaporization chamber 5. This valve 17 may be a manually actuated needle valve.
Vapor compression zone 32 comprising an area in the vaporization chamber 5 located immediately above the freshwater liquid level where vapor is compressible to the point of condensation.
Freshwater funnel 8 comprising a structure that connects the freshwater side of the vaporization chamber 5 to the freshwater suction line 9, to permit egress of freshwater from the vaporization chamber 5.
Freshwater suction line 9 comprising piping that transports freshwater from the freshwater funnel 8 to the one or more spring-loaded pumps 22.
Freshwater modulating valve 11 configured to ensure that condensation takes place within the vaporization chamber 5, and helps maintain the desired water level on the freshwater side of the vaporization chamber 5. The freshwater modulating valve 11 may comprise a manually actuated needle valve.
Spring-loaded pump 22 (FIG. 2C), as part of a pump system, designed and configured to operate effectively with very low pressure on its suction side. Low pressure on the suction side is pressure less than ambient atmospheric pressure. Moreover, low pressure at the suction side may be as low as, e.g., about 0.2 psi, but may vary. The spring-loaded pumps may operate in the range of about 0.2 psi to just less than ambient atmospheric pressure. When compared with typical atmospheric pressure, which may be around 14.7 psi, the operational low pressure capability of the spring-loaded pumps becomes more apparent.
A spring 50 arranged and contained within the pump 22 is configured to cause water from the suction side to flow towards the pump 22. The pump 22 may be configured with 2 water inlets 204a & 205a and 2 water outlets 204b & 205b (shown in FIG. 2C and FIG. 2D). One inlet and outlet pairing is dedicated to freshwater flow, while the other inlet and outlet pairing is strictly for brine flow. Pump valves installed on the suction and discharge lines control the freshwater and brine flows. A wall inside the pump, called the pump partition 23, separates freshwater flow from brine flow. Each pump 22 may be configured to include a linear actuator or pump press 230 at its bottom that compresses the spring when extended and forces water to flow outwards. For the prototype, a collection of 4 spring-loaded pumps is proposed to maintain continuous flows, with each pump's linear actuator electrically operated by the control panel. Also, each pump has an air vent inlet to accommodate air escaping from the vapor compression zone, as well as an outlet for the recycled water line.
Pump partition 23 comprising a wall configured to create two separate compartments inside the pump that keeps freshwater flow separate from brine flow within the pump 22. The pump partition 23 may be positioned within the pump in a manner that results in the desired ratio of freshwater flow versus brine flow. The pump partition 23 may be configured such that approximately 55% of the cross-sectional area is designated for freshwater and recycled water flow, while the remaining 45%, approximately, is reserved for brine flow.
Pump valves comprising a collection of valves 20, 21, 24 and 25 that controls the flows entering and exiting each pump 22. Each pump 22 may be configured with the same number and type of pump valves 20, 21, 24 and 25. The collection of valves 20, 21, 24 and 25 may comprise four ball or elliptical valves per pump 22. For each pump 22, one valve may be configured for the freshwater suction line (valve 20), freshwater discharge line (valve 24), brine suction line (valve 21), and brine discharge line (valve 25). All four valves per pump may be electrically actuated through a control panel 35. For a system 100 that is configured with four pumps to maintain continuous flows, the total number of pump valves is typically 16. It is possible to have a system configured with more or less pumps, with more or less valves accordingly.
Freshwater discharge line 28 comprising piping that transports freshwater from the spring-loaded pumps 22 to the freshwater storage area 29.
Recycled water storage container 15 comprising a container subject to atmospheric pressure to which a portion of the freshwater discharge is sent. Water in this container is recycled into the suction side of the pumps 22, either at the vaporization chamber 5 or downstream of the vaporization chamber
Recycled water line 18 comprising piping that transports freshwater from the pump discharge line 28 to the recycled water storage container 15. A check valve 26 may be installed on the recycled water line to prevent the backflow of water from the recycled water storage container 15 into the pump 22.
Recycle valve 19 comprising a valve that controls the flow of freshwater entering the recycled water storage container 15. In this case, the recycle valve 19 may be a manually actuated needle valve.
Brine funnel 6 comprising a structure that connects the seawater/brine side of the vaporization chamber 5 to the brine suction line 10.
Brine modulating valve 12 comprising a modulating valve designed to help maintain the desired water level on the seawater/brine side of the vaporization chamber 5, and to help balance the pressure acting on the downstream spring-loaded pumps 22. For one version of the system, the modulating valve is a manually actuated needle valve.
Brine discharge line 30 comprising piping that transports brine from a spring-loaded pump 22 to the brine storage area 31.

FIG. 2A is an example of a spring 50 shown in a free or uncompressed position, configured according to principles of the disclosure. FIG. 2B shows spring 50 in a fully-compressed position. The spring 50 may include multiple coils denoted as coils 90-99. The spring 50 may be utilized in the pump 22 to cause expansion of the pump 22.

FIG. 2C is an illustration of a pump 22 with pump press 230 shown in an extended or a post compression position, configured according to principles of the disclosure. FIG. 2D is an illustration of a pump 22 shown in a recessed or post-expansion position. The pump 22 may comprise a canister 202, the canister 202 comprising a top section 206, an outer shell of a middle section 210, an inner shell of the middle section 215, an outer shell of a bottom section 220 and an inner shell of the bottom section 225. A pump partition 23 is configured to create two separate compartments 240, 245. Compartment 240 is to contain brine 240 and compartment 245 is to contain freshwater. Compartment 240 is configured with inlet 204a and an outlet 204b for the brine water and connected to suction and discharge piping. Compartment 245 is configured with inlet 205a and outlet 205b for the freshwater and connected to suction and discharge piping. In operation, the pump 22 pumps brine water and freshwater simultaneously in compartments 240, 245. The spring 50 may be configured around the inner shells of the canister 202. The inner shells and pump partition 23 are constructed to be compressible. A pump press 230 may be employed to cause compression of the pump canister 202. The pump press 230 may be electrically or hydraulically powered. An adjustable pump pedestal 250 may be utilized for securing the pump 22 to a platform.

The following sections discuss some factors that are significant in the design of the system 100.

Piping

In general, piping that transports water in system 100 should be sized to accommodate flow velocities ranging from 1 to 8 feet-per-second (fps), with velocities ranging from 2 to 5 fps being preferred. Sizing piping within these flow velocity limits helps prevent excessive thrust loads and the deposition of solids. This sizing criteria also assists in ensuring that the phase change cycle (i.e., vaporization, vapor compression, condensation, and heat transfer) occurs within the vaporization chamber 5, since the flow velocities stay within a manageable or controllable range. Pipe sizes should also be designed in combination with the positioning of the pump partition 23 to balance the pressures exerted upon a pump 22. For instance, if the pump partition 23 is positioned to produce 90% freshwater and 10% brine from source seawater, then the diameter of the freshwater piping should be approximately 3 times the diameter of the brine piping. This is because the piping's cross-sectional area, which is a function of diameter squared, plays a significant role in imparting friction on water flow. Choosing pipe sizes with cross-sectional areas for freshwater and brine lines that correspond to the desired ratio of freshwater to brine production helps balance the friction forces resisting the pump, thereby minimizing pump wear.

The brine modulating valve 12 also helps balance pressures exerted upon the pump 22, particularly since vapor pressures inside the vaporization chamber 5 are different between the freshwater and brine sides. However, sizing pipe lines properly is one way to achieve balanced pressures on the pump 22. In one working model, all suction and discharge lines were sized at 6 mm outer diameter (4 mm inner diameter) to accommodate flow velocities of about 1 to 2 fps.

Vaporization Chamber

The vaporization chamber 5 is home to perhaps the most interesting, impressive, and powerful aspects of the disclosure. It is where renewable energy in the form of atmospheric pressure is used to compress and condense vapor into water; it is where the heat released from vapor compression and condensation is captured and transferred to where it is needed for vaporization, it is where vaporization takes place; and consequently, it is where salt and other impurities are removed from source water. All this occurs within a unique containment apparatus with an upstream saltwater bath separated by a partition from a downstream freshwater bath, but with both baths in direct contact with the same mixed gas canopy (or cover) of water vapor and air. The vaporization chamber comprises a central aspect of the disclosure, which is to enhance the phase change cycle associated with the known phenomenon of cavitation without damaging equipment and infrastructure by dictating where and when the cavitation occurs. Cavitation is located in a large container where the heat energy released by vapor compression and condensation can be dissipated, and it occurs before the saltwater or contaminated water reaches the pumps. The vaporization chamber 5 answers where and when to activate enhanced cavitation and its phase change cycle.

Temperature and pressure are important factors when configuring the vaporization chamber 5. By conducting lab experiments and running computer models, it was determined that causing cavitation's phase change cycle to occur at a relatively rapid rate results in a significant increase in temperature and pressure within the vaporization chamber 5. The smaller the chamber, the higher the temperature and pressure will reach inside the container 5.

However, a particular system configuration should consider both minimizing the size of the vaporization chamber 5 and providing reasonable operating conditions for the system's components. For example, most plastic cannot function properly above 140 degrees Fahrenheit. Additionally, the pressure needs to be considered with respect to the air vent. A check valve 27 may be installed on the air vent line 16 to prevent the backflow of water from inside the pump 22, and that check valve 27 needs a certain differential pressure in order to open. Accordingly, the vaporization chamber 5 needs to be sized such that the inside pressure at the vapor compression zone 32 will be sufficiently large to force open the air vent's check valve 27. The vaporization chamber may take on different shapes such as, e.g., rectangular or square.

The vaporization chamber 5 configuration also needs to include space for the vapor compression zone 32 along the heat exchanger 7 on its freshwater side. This space starts at the top of the heat exchanger and extends downwards to the water level below. Locating the vapor compression zone in this space helps trap the vapor from horizontal movement, thereby forcing its compression vertically from the downstream freshwater.

The vaporization chamber 5 is typically sized to result in inside temperatures ranging from about 68 to about 106 degrees Fahrenheit, with corresponding vapor compression zone 32 pressures that are more than capable of opening the air vent's check valve, if installed. It is important to note here that the corresponding vapor compression zone pressures rely not only on water's liquid-vapor equilibrium, but also on the amount of soluble air released into the vaporization chamber 5 due to the low pressure conditions. Furthermore, the chamber's exterior walls should be resistant to heat flow and adequately thick to minimize heat loss to the surroundings. The vaporization chamber 5 may comprise a thermal barrier configured around or as part of the chamber.

An application for small amounts of freshwater production may have a chamber as small as 6″ in diameter. However, for larger applications, the diameter of the vaporization chamber 5 may be selected from a range of about 1′ to about 100′, but the vaporization chamber 5 may have a larger diameter depending on freshwater production requirements.

Recycled Water Using Atmospheric Pressure

In one aspect, the system 100 may be configured to introduce air at atmospheric pressure into, or downstream of, the vaporization chamber 5 in order to force vapor compression and condensation where desired in the vaporization chamber. Though introducing air can achieve this effect, lab experiments and computer model runs have demonstrated that introducing water backed by atmospheric pressure is the preferred method. First, introducing air into the system 100 means more air to be pumped out of the system 100, which lowers the energy efficiency with respect to freshwater production. Second, modeling the friction imparted by air is much more difficult than modeling the friction imparted by water. For these two reasons, the preferred technique introduces water, instead of air or a mixture of water and air, to force vapor compression and condensation in the vaporization chamber 5. In this context, air means ambient or gaseous air, not air dissolved in water.

The recycled water storage container 15 may be the source of the introduced water. This container 15, which is replenished with freshwater from the discharge side of the pumps 22, is intentionally left open to atmospheric pressure. A cover may be provided to limit air infiltration or entrainment into the recycled water, but the cover must rest directly on the water level so that atmospheric pressure remains the driving force for flow into, or downstream of, the vaporization chamber 5. Freshwater flow from inside the vaporization chamber 5 will then be forced to match pressures with the atmospheric pressure driven recycled water at the junction of the two flows, and this matching of pressures can only occur through compression and condensation of the upstream vapor.

Based upon computer modeling, the recycled water flow is about 10% to about 20% of the freshwater produced from vapor compression and condensation. In one version of the system, the recycled water flow is approximately 15% of the freshwater production.

Initial Vapor Creation

To set up the enhanced cavitation process, an initial amount of vapor must be created within the vaporization chamber 5. This initial vapor acts as starter fuel for a phase change cycle process, and it can be created through the addition of heat, the implementation of vacuum technology, or both. In one implementation, heat addition combined with vacuum technology is used as the means to provide the initial vapor. The heat exchanger 7 may be equipped with, e.g., a winding heating element that can be activated to provide up to 500 W of heat energy into the vaporization chamber 5. Heat addition may be activated under vacuum conditions, with either the spring-loaded pumps or an external vacuum pump providing the low-pressure conditions.

After the initial vapor is created, heat addition should be stopped. Other than the work performed by atmospheric pressure and the recycled water it pushes, no more energy should be required to produce vapor and perpetuate the phase change cycle process. This is true as long as operation remains continuous. If the process must be stopped for repair, maintenance, or any other reason, then the initial vapor creation must be repeated to start the phase change cycle again. Because the initial vapor creation can take several hours or even days to complete, it is important that, once started, the process operate continuously for as long as possible to preserve reasonable energy efficiencies.

As an explanatory note, in one aspect, continuous operation of the desalination process includes using the spring-loaded pumps to induce all water flows (seawater, freshwater/recycled water, and brine) after the initial vapor has been created inside the vaporization chamber. This is the operation that should remain continuous as much as possible.

Heat Exchanger

Regardless of whether it is configured to provide heat for initial vapor creation, or whether it is used to separate freshwater from seawater/brine, the heat exchanger 7 must be capable of transferring heat from the freshwater side of the vaporization chamber 5 to the seawater/brine side. Ultimately, heat transfer is the primary duty of the heat exchanger.

In one version, the heat exchanger may be an approximately 1.3 centimeter thick copper plate that transfers about 9,500 W of heat by conduction. A winding heating element may be embedded in the copper plate to permit heat addition when desired. The example heat exchanger may also serve as the barrier wall between the freshwater and seawater/brine sides of the vaporization chamber 5.

Total Energy Balance

A total energy balance was conducted to verify that the intended output associated with the system and process of the disclosure during continuous operation (after initial vapor creation) is indeed possible and do not violate the laws of physics. The total energy balance was divided into two parts: The first part involved the phase change cycle energy inside the vaporization chamber 5, and the second part dealt with the energy required to pump water to (i.e., seawater) and from (i.e., freshwater/recycled water and brine) the vaporization chamber 5.

The total energy balance is as follows:

Total Energy=rQ∫dU+P∫dQ+Q∫dP+rQ∫vdv+rQg∫dZ+h_{L} (Eq. 1)

Where:
r=density Q=flowrate
P=Pressure g=acceleration due to gravity
h_{L}=energy (head) loss due to friction ∫dU=Internal Energy Integral
∫dQ=Flowrate Integral ∫dP=Pressure Integral
∫vdv=Velocity Integral ∫dZ=Elevation Integral
   FIG. 3 is a more detailed description of Equation 1.

Phase Change Cycle Energy

The energy balance for the phase change cycle includes a heat component as well as a work component. The temperature gradient that develops inside the vaporization chamber 5 means that this energy's heat component terms cannot be discounted. However, the elevation, velocity, and friction terms can be considered negligible and eliminated. The resulting phase change cycle energy balance is as follows:

Phase Change Cycle Energy=rQ∫dU+P∫dQ+Q∫dP (Eq. 2)

Heat Energy

Because vaporization specifically requires heat energy, it is worthwhile to conduct a heat energy balance for the phase change cycle. Narrowing the energy balance accordingly results in the following:

Heat Energy=rQ∫dU+P∫dQ (Eq. 3)

Equation 3 should be applied to all three steps of the phase change cycle: vaporization, vapor compression, and condensation. The amount of heat released from condensation and vapor compression should equal or exceed the amount of heat absorbed during vaporization. Computer model runs confirm this heat to be approximately 650 kWh of energy per cubic meter of water produced. This is the heat energy that is transferred by the heat exchanger 7 from the freshwater side to the seawater/brine side of the vaporization chamber 5. Parenthetically, it is also the heat transferred by convection in the water baths (freshwater and seawater/brine) on both sides of the vaporization chamber. For the same system, this heat energy remains relatively constant even if the salinity of the source seawater changes dramatically.

Work Energy

This work energy specifically refers to the work associated with the phase change cycle, which is the work required to compress the vapor inside the vaporization chamber 5 to the condensation point. Removing the heat terms from the phase change cycle energy balance leaves the work energy balance, which is as follows:

Work Energy(Vapor Compression)=Q∫dP (Eq. 4)

Unlike heat energy, this work energy is somewhat sensitive to the salinity of the source seawater. For the same system, an increase in salinity of the source seawater will produce a moderate increase in vapor compression work.

Pumping Energy

Here, pumping energy means the energy needed by the spring-loaded pumps 22 to maintain continuous flows of seawater, freshwater/recycled water, and brine. For pumping energy, the heat and velocity terms can be discounted from the total energy balance, and the endpoint pressure at the seawater source, freshwater storage, recycled water storage, and brine storage is assumed to be constant atmospheric pressure. The resulting equation is as follows:

Pumping Energy=rQg∫dZ+h_{L} (Eq. 5)

Pumping energy is affected by changes in salinity of the source seawater because water recovery percentages are affected. For example, high salinity saltwater (>10% salinity per unit pure water) may not permit water recovery greater than 50%, which means approximately double the pumping energy may be required per cubic meter of freshwater produced as compared to lower salinity source seawater (3.5% salinity per unit pure water) and its 90% water recovery.

Energy Inputs

The energy requirements for the system and process of the present disclosure are met by two different sources. One source is electrical energy, which is assumed to be generated from fossil fuels. However, this is not a requirement, as the electrical energy could very well be generated by solar power or some other means of renewable energy. The other source is renewable energy provided by atmospheric pressure. The combination of the two energy sources provides all the energy required by the system 100 and process, but the ratio of renewable energy versus electrical energy is one of the aspects that makes the system and process of the present disclosure unique.

Electrical Energy Input

The primary demand of electrical energy comes from the spring-loaded pumps 22. It is anticipated that the pumps 22 will typically account for approximately 75% of the electrical energy consumption, although this can vary. Other equipment that demands electricity include the control panel, lights, automated valves, and the heating element inside the heat exchanger. Fortunately, the heating element will only be active during initial vapor creation, which should occur sparingly.

For larger applications (producing about 10 cubic meters per day or more of freshwater), the electrical energy input is expected to be approximately 0.12 kWh per cubic meter of freshwater produced. For a small-scale application producing about 0.33 cubic meters per day of freshwater, the electrical energy input is estimated to be 0.24 kWh per cubic meter of freshwater produced. These values vary with respect to salinity of the source seawater, based on allowable water recovery percentages.

Renewable Energy Input

Atmospheric pressure serves as the renewable energy input for system and process of the present disclosure. By driving recycled water into the vaporization chamber 5, it provides all of the work energy necessary to compress the vapor inside the vaporization chamber to the condensation point.

The work performed by atmospheric pressure on the system 100 may be an astounding about 50 kWh per cubic meter of freshwater produced. This is based on source seawater salinity of approximately 3.5% per unit pure water. If the source seawater rises to 14.0% salinity, then the work performed by atmospheric pressure increases to roughly 55 kWh per cubic meter of freshwater produced. System configurations for larger applications have demonstrated that work performed by atmospheric pressure can reach approximately 300 kWh per cubic meter of freshwater produced. Regardless the scenario, the work performed by atmospheric pressure (50 to 300 kWh) is much greater than the electrical work performed by the spring-loaded pumps 22 and other equipment (0.12 to 0.24 kWh). Most importantly, the work performed by atmospheric pressure is entirely driven by renewable energy, requiring no additional electrical energy or fossil fuel input.

Applications

For larger scale applications producing approximately 10 cubic meters or more of freshwater per day, a system designed according to principles herein can treat typical seawater at an energy efficiency of 0.12 kWh or lower per cubic meter of freshwater produced, while recovering up to 90% of the seawater as freshwater and losing as little as 10% as brine (90% water recovery). For a smaller scale application, a system configured according to principles of the disclosure to such a scale may produce approximately 0.33 cubic meters per day of freshwater from typical seawater at an energy efficiency of approximately 0.24 kWh per cubic meter of freshwater produced. For each cubic meter of seawater that is treated, approximately 50% is converted into freshwater (50% water recovery). The 50% that remains after treatment is high salinity (approximately 7% salinity per unit pure water) waste or brine. The system 100 may produce from about 0.01 gpm to about 1,080 gpm, or more, depending on system sizing.

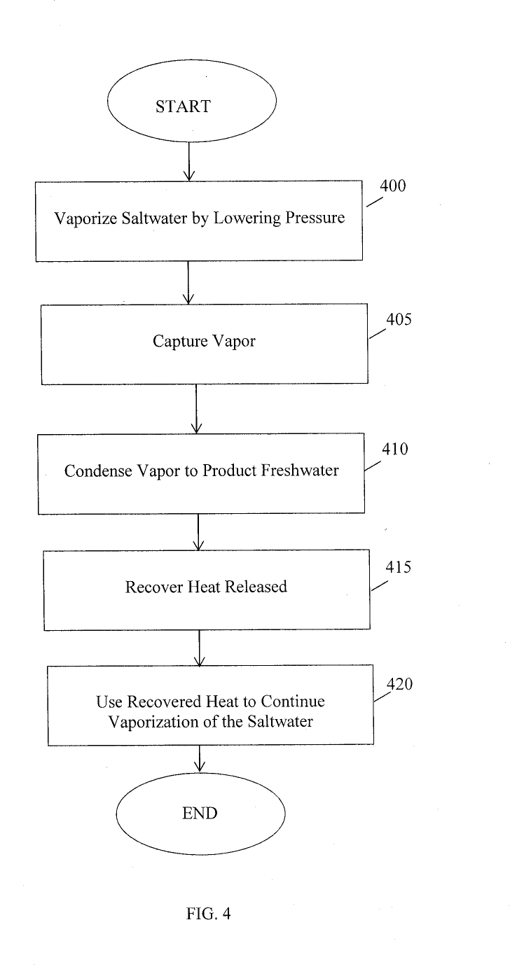

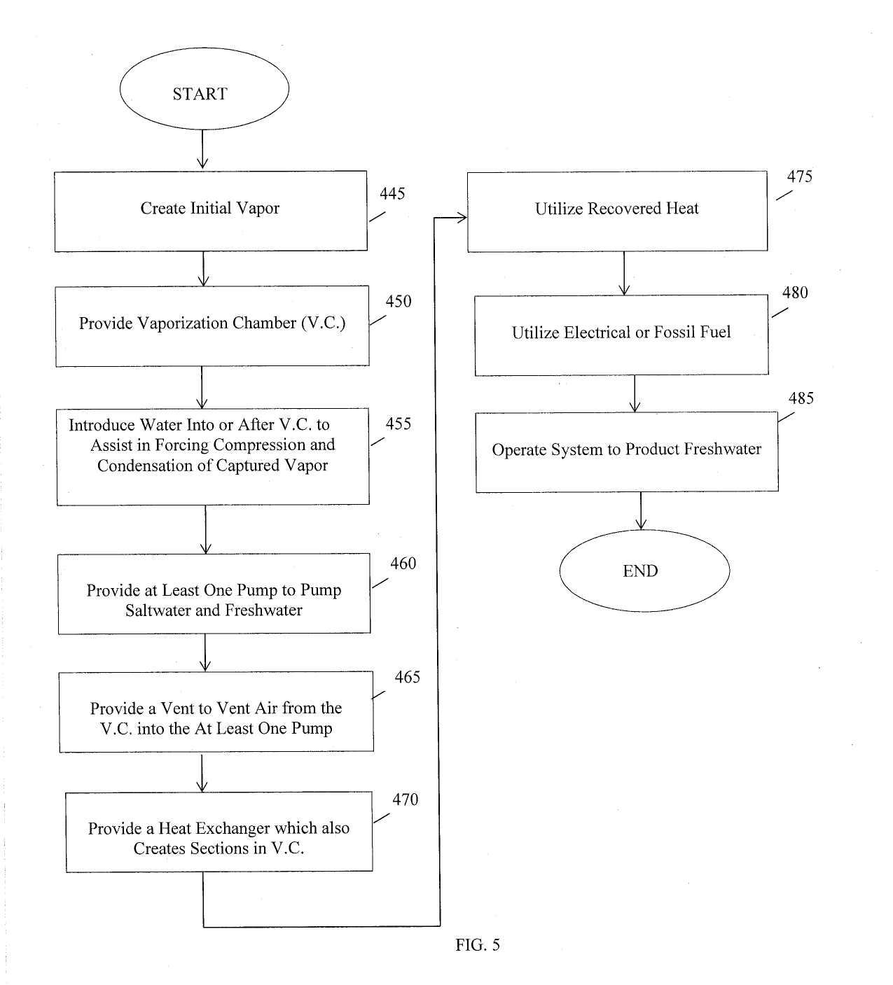

The system 100 may be controlled by a control panel 35. The control panel 35 may include a computer. The computer may monitor and oversee operational controls of the various components described herein. The computer may be controlled by software that may be configured to control the various steps described herein. The software may be stored on computer readable medium that when read and executed by the computer may perform or control one or more of the steps of the processes herein such as one or more of the steps of FIGS. 4 and 5. As shown in FIG. 1A, the control panel 35, computer with software may be in communication with and control, e.g., one or more valves, one or more pressures, pump operations, water levels, the heat source for initial vapor creation, and the like. The computer may also record freshwater production output.

FIG. 4 is an example flow diagram of a process, the steps of the process performed according to principles of the disclosure. At step 400, liquid saltwater may be vaporized by lowering the pressure of liquid saltwater to a vaporization point by generating saltwater flow through piping and accompanying infrastructure to produce vapor. This may be accomplished by using a system such as shown in FIG. 1A-1C. The accompanying infrastructure may comprise at least one valve to impart friction. At step 405, the vaporized vapor may be captured and/or contained, such as, e.g., in vaporization chamber 5. At step 410, the vapor may be condensed to produce freshwater using higher pressure supplied by ambient surroundings. The ambient surroundings may be the ambient atmospheric pressure. At step 415, heat released during the condensation step may be recovered, minimizing heat loss to ambient surroundings. This may also significantly improve energy efficiency of the process. At step 420, the recovered heat is used to enhance and continue vaporization of the saltwater in a cyclical manner.

FIG. 5 is an example flow diagram of a process, the steps of the process performed according to principles of the disclosure. At step 445, an initial vapor may be created using a heat source and/or vacuum technology prior to, or along with, vaporizing liquid saltwater to create an initial vapor condition. Subsequently the use of the heat source and/or vacuum technology may be discontinued to permit the cyclical manner to proceed to produce the freshwater. At step 450, a vaporization chamber configured with an upstream side to retain the saltwater and configured with a downstream side to retain the freshwater may be provided. The vaporization chamber may be configured to employ atmospheric pressure to act as a renewable energy resource that assists in compressing and condensing the captured vapor to produce the freshwater. The vaporization chamber is configured to allow a phase change cycle associated with cavitation to occur in a safe environment. At step 455, water may be introduced into or after the vaporization chamber to assist in forcing compression and condensation of the captured vapor. This condensing may produce freshwater at a constant flow of about 0.01 gpm to about 1,080 gpm, or more. This may depend on the size of the system used. At step 460, at least one pump may be provided to pump the saltwater to generate the saltwater flow through the piping and the accompanying infrastructure to the upstream side of the vaporization chamber, while also pumping the freshwater from the downstream side of the vaporization chamber to a storage area. The at least one pump may include providing a pump configured to pump both the saltwater and the freshwater simultaneously with at least one same pump wherein the saltwater and freshwater flow simultaneously but separately through the same at least one pump. The at least one pump may be configured to pump both the saltwater and the freshwater simultaneously with a plurality of spring-loaded pumps that are each expanded by a spring. The plurality of spring-loaded pumps may be operated in rotation so that each of the plurality of pumps pump both the saltwater and the freshwater simultaneously to maintain a continuous flow of saltwater into the upstream side of the plurality of pumps and a continuous flow of freshwater from the downstream side of the plurality of pumps.

At step 465, air may be vented from the vaporizing chamber into the at least one pump when pressure inside the vaporization chamber rises above the pressure within the at least one pump whereby the vented air comes out of solution in the vaporization chamber due to vacuum conditions present within the vaporization chamber. At step 470 or, alternatively, as part of step 450, a heat exchanger (e.g., heat exchanger 7) may be provided within the vaporization chamber that creates a first section to contain the saltwater and creates a second section to contain the freshwater, the heat exchanger separating the saltwater from the freshwater and configured to pass heat from the contained freshwater to the contained saltwater to promote vaporization of the saltwater. The recovered heat may recycle about 650 kWh of heat energy per cubic meter of freshwater produced to continue vaporization of the saltwater in the cyclical manner.

At step 480, about 50 to about 300 kWh per cubic meter of freshwater produced of renewable energy may be utilized that is provided in the form of atmospheric pressure to assist in the compressing and condensing of the water vapor, thereby creating freshwater. Moreover, about 0.12 to about 0.24 kWh of electrical energy or fossil fuel consumption per cubic meter of freshwater produced may be utilized. At step 485, the system may be operated in a continuous manner to produce freshwater.

While the disclosure has been described in terms of examples, those skilled in the art will recognize that the disclosure can be practiced with modifications in the spirit and scope of the appended claims. These examples are merely illustrative and are not meant to be an exhaustive list of all possible designs, examples, applications or modifications of the disclosure.

What is claimed is:

1. A method of desalination of water, the method comprising:
vaporizing liquid saltwater by lowering the pressure of liquid saltwater to a vaporization point by generating saltwater flow through piping and accompanying infrastructure to produce vapor;
capturing the vapor;
condensing the vapor to produce freshwater using higher pressure supplied by ambient surroundings;
recovering heat released during the condensing operation by minimizing heat loss to ambient surroundings; and
using the recovered heat to enhance and continue vaporization of the saltwater in a cyclical manner.

2. The method of claim 1, further comprising:
providing a vaporization chamber configured with an upstream side to retain the saltwater and configured with a downstream side to retain the freshwater, the vaporization chamber configured to employ atmospheric pressure to act as a renewable energy resource that assists in compressing and condensing the captured vapor to produce the freshwater.

3. The method of claim 2, further comprising:
introducing water into or after the vaporization chamber to assist in forcing compression and condensation of the captured vapor.

4. The method of claim 2, further comprising:
providing at least one pump to pump the saltwater to generate the saltwater flow through the piping and the accompanying infrastructure to the upstream side of the vaporization chamber while also pumping the freshwater from the downstream side of the vaporization chamber to a storage area.

5. The method of claim 4, further comprising:
venting air from the vaporizing chamber into the at least one pump whereby the vented air comes out of solution in the vaporization chamber due to vacuum conditions present within the vaporization chamber.

6. The method of claim 4, wherein the operation of providing at least one pump comprises:
providing a pump configured to pump both the saltwater and the freshwater simultaneously with at least one same pump,
wherein the saltwater and freshwater flow simultaneously but separately through the same at least one pump.

7. The method of claim 4, wherein the operation of providing a pump comprises providing a pump configured to pump both the saltwater and the freshwater simultaneously with a plurality of pumps that are each expanded by a force.

8. The method of claim 7, further comprising:
operating the plurality of pumps in rotation so that each of the plurality of pumps pump both the saltwater and the freshwater simultaneously to maintain a continuous flow of saltwater into the upstream side of the plurality of pumps and a continuous flow of freshwater from the downstream side of the plurality of pumps.

9. The method of claim 2, wherein the operation of providing the vaporization chamber includes providing a heat exchanger within the vaporization chamber that creates a first section to contain the saltwater and creates a second section to contain the freshwater, the heat exchanger separating the saltwater from the freshwater and configured to pass heat from the contained freshwater to the contained saltwater to promote vaporization of the saltwater.

10. The method of claim 2, wherein the vaporization chamber allows a phase change cycle associated with cavitation to occur in a safe environment.

11. The method of claim 1, wherein the operation of condensing the vapor producing freshwater produces a constant flow of about 0.01 gpm to about 1,080 gpm, or more.

12. The method of claim 1, wherein the accompanying infrastructure comprises at least one valve to impart friction.

13. The method of claim 1, wherein the operation of using the recovered heat recycles about 650 kWh of heat energy per cubic meter of freshwater produced to continue vaporization of the saltwater in the cyclical manner.

14. The method of claim 1, further comprising:
utilizing about 50 to about 300 KWh per cubic meter of freshwater produced of renewable energy provided in the form of atmospheric pressure to assist in the condensing operation or the vaporizing operation.

15. The method of claim 1, further comprising:
utilizing about 0.12 to about 0.24 kWh of electrical energy or fossil fuel consumption per cubic meter of freshwater produced.

16. The method of claim 1, further comprising:
creating initial vapor using a heat source prior to or with the operation of vaporizing liquid saltwater to create an initial vapor condition, and subsequently discontinuing the use of the heat source to permit the cyclical manner to proceed to produce the freshwater.

17. The method of claim 1, further comprising:
creating initial vapor using vacuum technology prior to or with the step for vaporizing liquid saltwater to create an initial vapor condition, and subsequently permit the cyclical manner to proceed to produce the freshwater.

18. Freshwater produced by the method of claim 1.

19. A system for desalination of saltwater, comprising:
a containment vessel configured to substantially enclose an upstream containment section and a downstream containment section, the upstream containment section configured to contain saltwater, the downstream section configured to contain freshwater, wherein the containment vessel is configured to permit a phase change to occur above both the upstream containment section and the downstream containment section via a gas canopy comprising a mixture of water vapor and air;
a heat exchanger that separates the upstream containment section from the downstream containment section and configured to pass heat from the downstream side to the upstream side to promote continual vaporization of the saltwater; and
a pump system to pump both saltwater from a saltwater source into the upstream containment section and to pump condensed freshwater from the downstream containment section, wherein friction in piping and fittings on a suction side of the pump system assists in lowering pressure in the containment vessel;
wherein water is introducible into the downstream containment section or into a suction line connected to the downstream containment section by using atmospheric pressure to assist in forcing vapor compression and condensation within the containment vessel to produce freshwater in the downstream containment section.

20. The system of claim 19, wherein the containment vessel is configured with a vent configured to vent air into the pump system to release pressure that has been created by air coming out of solution in the containment vessel due to an increase in vacuum within the containment vessel and wherein the pump system is configured to receive the vented air.

21. The system of claim 19, wherein the atmospheric pressure acts as renewable energy for forcing compression and condensation of the vapor, and to reduce energy consumption for the desalination.

22. The system of claim 19, wherein the pump system comprises a plurality of pumps configured to pump the saltwater/brine and the freshwater simultaneously therewithin.

23. The system of claim 19, further comprising at least one valve that controls friction imparted to a flow of saltwater on the suction side of the pump system comprising at least one pump to lower pressure of the saltwater towards the vaporization point causing vaporization of the saltwater within the containment vessel to produce water vapor; and
a source configured to inject water, air, or both into the containment vessel to force condensation of the water vapor into the downstream containment section thereby assisting desalinating the saltwater to produce freshwater.

24. The system of claim 23, wherein the injected water/air is injected with a higher pressure and a higher temperature than the produced water vapor.

25. The system of claim 23, wherein the injected water/air is injected with a higher pressure and a temperature that is about equal to or lower than the produced water vapor.

26. The system of claim 23, further comprising a thermal barrier configured around or as part of the containment vessel.

27. The system of claim 19, wherein the pump system comprises at least one pump configured with an expansion cavity that expands primarily by force and the at least one pump is configured to operate at low pressure conditions on its suction side of less than ambient atmospheric pressure.

28. The system of claim 27, wherein each of the plurality of pumps is configured with an expansion cavity that is configured to be compressed by a pump press device.

29. The system of claim 19, wherein the system consumes 0.12 to about 0.24 kWh of electrical energy or fossil fuel per cubic meter of freshwater produced.

30. The system of claim 19, wherein a freshwater production rate of about 1,080 gpm or greater is achievable.

31. The system of claim 19, wherein the system consumes from about 50 to about 300 kWh of renewable energy per cubic meter of freshwater produced, the renewable energy being in the form of atmospheric pressure.

32. The system of claim 19, wherein the heat exchanger recycles about 650 kWh of heat energy per cubic meter of freshwater produced.

33. The system of claim 19, further comprising:
a brine modulating valve located between the upstream containment section of the vaporization chamber and the pump system to assist in maintaining desired water level in the upstream containment section, and assist in balancing pressure exerted on the pump system.

34. The system of claim 19, further comprising:
a freshwater modulating valve positioned on a freshwater suction line between the downstream containment section and the pump system to ensure that condensation occurs in the containment vessel, and assist in maintaining desired water level in same downstream containment section.

35. A system for desalination of saltwater, comprising:
a containment vessel configured to substantially enclose an upstream containment section and a downstream containment section;
a pump system for pumping both saltwater from a saltwater source into the upstream containment section and for pumping condensed freshwater from the downstream containment section, wherein the pump system comprises a plurality of spring-loaded pumps configured to pump the saltwater and the freshwater simultaneously;
at least one friction valve that controls friction imparted to a flow of saltwater on the suction side of a plurality of spring-loaded pumps to lower pressure of the saltwater to the vaporization point causing vaporization of the saltwater within the containment vessel to produce water vapor; and
an air source configured to inject air into the containment vessel to force condensation of the water vapor into the downstream containment section thereby desalinating the saltwater producing freshwater.

36. The system of claim 35, wherein the injected air is injected with a higher pressure and a higher temperature than the produced water vapor.

37. The system of claim 35, wherein the injected air is at about ambient temperature.

38. The system of claim 35, wherein each of the plurality of spring-loaded pumps is configured with an expansion cavity that expands solely by spring-loaded tension.

39. The system of claim 35, wherein each of the plurality of spring-loaded pumps is configured with an expansion cavity to be compressed by an electro-mechanical device.

40. The system of claim 35, wherein the plurality of pumps are configured to be operated in rotation to maintain a continuous flow of saltwater and freshwater.

41. The system of claim 35, wherein a freshwater production rate of about 1,080 gpm is achievable.

42. The system of claim 35, further comprising a heater exchanger to exchange heat between the downstream containment section and the upstream containment section.

43. A pump for pumping a fluid, comprising:
a housing of a predetermined circumference for containing at least one fluid, wherein the housing is configured with an expandable section;
a spring of about the same predetermined circumference and configured to expand the expandable section; and
a compression mechanism operable to compress the expandable section to force the at least one fluid from the pump,
wherein the housing is configured to house two separate compartments, each separate compartment configured to receive the at least one fluid from a separate inlet and each separate compartment configured to expel the at least one fluid through a separate outlet, wherein the spring expands the expandable section to fill each separate compartment with the at least one fluid from a respective inlet, and the compression mechanism compresses the expandable section to force the at least one fluid from each compartment through a respective separate outlet.

44. The pump of claim 43, wherein the at least one fluid is different for each separate compartment.

45. The pump of claim 43, wherein one compartment is smaller than the other compartment.
